(19) United States
(12) Patent Application Publication
(10) Pub. No.: US 2014/0304201 A1
(43) Pub. Date: Oct. 9, 2014

(54) System And Method For Identifying Suggestions To Remedy Wind Turbine Faults

(71) Applicants: Kim Hyldgaard, Sunds (DK); Henrik Simonsen, Aalborg (DK)

(72) Inventors: Kim Hyldgaard, Sunds (DK); Henrik Simonsen, Aalborg (DK)

(21) Appl. No.: 14/358,676

(22) PCT Filed: Nov. 15, 2011
(86) PCT No.: PCT/DK2011/000134

§ 371 Date: May 15, 2014

(51) Int. Cl. G05B 13/00; G06N 99/00

(52) U.S. Cl. CPC G05B 13/00; G06N 99/005
USPC 706/12

(57) ABSTRACT

A method of automatically identifying suggestions regarding how to remedy wind turbine faults is provided, including establishing and storing a plurality of fault reports, each fault report including fault symptom information including data of identified fault symptoms of a previously occurred fault and fault remedy information, the fault remedy information including data regarding how the previously occurred fault was remedied, collecting fault related data, which includes data from one or more wind turbines exposed to an occurring fault, by a data processing arrangement performing data processing, including correlation of the fault related data with data from the stored fault reports, and based on the correlation establishing one or more fault remedy suggestions including suggestions regarding how to remedy the occurring fault related to the wind turbines based on the data processing. The invention also relates to a system for automatically identifying suggestions regarding how to remedy wind turbine faults.

### FIELD OF THE INVENTION

The invention relates to a system and a method for identifying suggestions to remedy occurring faults that wind turbines are exposed to.

### BACKGROUND OF THE INVENTION

The amount of wind turbines installed and connected to the utility grid has increased drastically over the recent years and continues to increase, and no matter the improvements in the operation stability of wind turbines, the wind turbines are sometimes taken out of operation due to occurred faults e.g. to assure safety, to avoid unintended wear of wind turbine components, due to wind turbine components being broken, due to utility grid faults etc.

When a wind turbine is out of operation due to a fault, it is desirable to correct/remedy the fault as fast as possible to get the wind turbine back into operation fast and cost efficiently.

An example of a system for handling wind turbine faults is disclosed in EP2290233, where operational information on operational characteristics of a wind turbine is analyzed based on a set of rules to detect if the fault in a wind turbine is resettable, and if the wind turbine is determined to be resettable, the wind turbine is reset.

### SUMMARY OF THE INVENTION

It is an object of the invention to provide a system and method that may help to provide information in relation to remedying faults in one or more wind turbines.

The invention relates to a method of automatically identifying suggestions regarding how to remedy wind turbine faults, said method comprising:
establishing and storing a plurality of fault reports, each fault report at least comprising:
   fault symptom information comprising data of identified fault symptoms of a previously occurred fault, and
   fault remedy information, said fault remedy information comprising data regarding how said previously occurred fault was remedied,
collecting fault related data, said fault related data at least comprising data from one or more wind turbines exposed to an occurring fault,
by means of a data processing arrangement performing data processing, said data processing comprising correlation of said fault related data with data from one or more of said stored fault reports, and
based on said correlation establishing one or more fault remedy suggestions comprising suggestions regarding how to remedy said occurring fault related to said one or more wind turbines based on said data processing.

By the above, several advantages may be obtained. For example, suggestions regarding how to remedy a given fault can be automatically established based on solutions performed to remedy previously occurred faults. Thus experiential data is automatically incorporated when trying to suggest solutions to remedy the occurring fault.

For example, if a number of fault reports comprises fault symptom information that seem to correspond with some of the fault related data from an occurring fault, the remedying of the faults to which these fault reports relates may often be considered as especially relevant in relation to remedying the occurring fault.

Also, it may by the present invention be possible to avoid sending repairmen/service personnel to a wind turbine to remedy a fault that may be remedied remote due to the established fault remedy suggestions by e.g. resetting a wind turbine control system.

Also, by the present invention it may be obtained that service personnel can be informed about the nature of the occurring fault and/or possible relevant spare parts to bring to the wind turbine to remedy the fault. This may reduce the time that a wind turbine is out of operation.

Also, in aspects of the present invention, it may be possible to establish fault remedy suggestions without necessarily knowing the cause of the occurring fault and/or the fault diagnosis of the occurring fault. The reason for this may be that the fault remedy suggestions may be based on the collected fault related data that is relevant to the occurring fault and fault remedy information and fault symptom information of the fault reports. So hereby, a fast suggestion to the remedy of the fault may be established without necessarily knowing the cause for the fault.

However, in aspects of the invention as described later on, the system may also be capable of establishing suggestions to the cause of the occurring fault and/or suggestions to diagnose the occurring fault.

It is furthermore to be noted, that the present invention may be considered especially advantageous in relation to remedying faults after they occurred.

By the term “fault related data” is to be understood data that is relevant in relation to the occurring fault. As stated above, the fault related data comprises data from one or more wind turbines exposed to the occurring fault, but it may also comprise data from other sources such as e.g. meteorological data, data collected from components of the utility grid such as sub stations, transmission lines, distribution lines etc. data from relevant wind turbines not being exposed to the occurred fault, etc. Thus, the fault related data may be considered as input data to the system of the present invention that comprises various data relevant in relation to establishing e.g. suggestions to solutions to the occurring fault.

It is to be understood that the system of the present invention in aspects may collect a plurality of input data from different sources and analyze this data with respect to data of fault reports so as to identify relevant fault related data that may help to identify suitable fault remedy suggestions. For example, the input data may comprise parameter settings of wind turbines, stored historical data, wind turbine setup data etc. that may be correlated with fault symptom information so as to identify relevant input data that may be further correlated with fault remedy information.

It is understood that the occurring fault does not necessarily need to be occurred in a wind turbine exposed to a fault. For example, the occurring fault may be a fault occurred in the utility grid, e.g. in a transformer in the utility grid. This may result in one or more wind turbines being out of operation and/or being exposed to the fault even though the occurring fault is a fault occurred external to the wind turbine(s) exposed to the fault.

Preferably, the fault reports, e.g. stored in a fault report database, are incorporated by means of one or more predefined data structures so that the data in the fault report is indexed in one or more predefined ways allowing easy search and access to the data of the fault reports.

In a preferred aspect of the invention, the method further comprises automatically establishing one or more a new fault reports based on said data processing, said one or more new fault reports comprising:
fault symptom information describing one or more fault symptoms of said occurring fault, and
fault remedy information, said fault remedy information comprising information regarding how to remedy said occurring fault.

Thus, knowledge obtained during the remedying of the occurring fault can be automatically reused later on by processing the new established fault report i.e. the new fault report is preferably not finally established before the occurring fault has been remedied.

Also, a continuous and automatic update of the fault reports based on the development and changes in wind turbines may be obtained. As an example it could be mentioned update of software in the control system the content, time etc. related to such update may be stored for later use in the correlation made by the data processor to suggest a remedy to an occurring fault.

Furthermore, it may result in that the system over time gets more and more reliable since data is continuously added to the system.

In general it is to be understood that fault reports may also be established and added to a fault report database based on a plurality of logged information, based on service personnel manually establishing a fault report, e.g. based on a predefined template defined by means of software on a portable user unit.

In an aspect of the invention, the method comprises updating one or more existing fault reports in a fault report database based on said data processing.

Thus, new relevant data may e.g. be added to existing fault reports.

In an aspect of the invention, one or more new fault reports and/or the updating of said one or more existing fault reports in said fault report database is/are being reviewed and if verified by an expert user by means of expert user input.

This may serve several purposes. Expert experience obtained during the remedying of the occurring fault may e.g. be incorporated in the new and/or updated fault report. Hence obtained knowledge may then automatically be utilized during later processing in relation to new faults. Also the expert user may add further clarifying information to the existing automatically generated information in the fault report.

Also, by having an expert user verifying the fault report, the credibility of the fault reports may be increased because the expert user preferably would be an expert in that particular technical area and e.g. a developer, serviceperson, etc.

In a preferred aspect of the invention, the one or more new fault reports and/or the one or more updated fault reports are subsequently automatically utilized for establishing one or more fault remedy suggestions comprising suggestions regarding how to remedy a subsequent occurring fault in one or more wind turbines.

As an example, a new fault report relating to an occurring fault may be automatically established by the system. An expert user reviewing the report adds to the report that it was subsequently discovered that a short circuit in a sub-station close to the wind turbine caused the fault. Furthermore, the expert may add that an exchange of a component in the wind turbine exposed to the fault was suggested by the system, but it turned out that in the given situation the component could probably be repaired at the wind turbine by bringing a couple of specific smaller spare parts to the wind turbine. For example, before the expert user verifies and accepts the fault report, the above may be added to the automatically generated information of the fault report. Thus, later on, if the new verified fault report is identified as relevant to another fault, the fault related information added by the expert user (e.g. that it may be possible to remedy a comparable or similar fault by bringing and exchanging spare parts in the component at the wind turbine) may be automatically generated information in a new fault report related to the comparable or similar fault. Furthermore information of the origin of the fault (e.g. that it is likely that a short circuit in the utility grid nearby may have caused the fault) may also automatically generated information in the new fault report to the user.

In an aspect of the invention, one or more of said one or more wind turbines from which said fault related data is collected are out of operation due to said occurring fault.

In aspects of the invention, the present invention may be especially advantageous for use in relation to remedying faults in wind turbines which are out of operation. Also, in aspects the wind turbine(s) may be de-rated as consequence of the fault.

In a further aspect of the invention, the processing furthermore comprises establishing probability information for one or more of said established fault remedy suggestions, said probability information comprising information regarding the probability of said one or more fault remedy suggestions remedying said occurring fault.

By this a user may e.g. select one or more fault remedy suggestions to be conducted to remedy the fault. Also, it may help a user to select between fault remedy suggestions that may not be the most probable to remedy the fault, but which seems to be the most cost efficient solution. For example, the system may estimate that exchanging a component in a wind turbine is the most probable solution to remedy an occurring fault, but that there is also a small chance that e.g. a resetting of a wind turbine may remedy the fault. Thus, a resetting of the wind turbine may be relevant to try before sending service personnel to a wind turbine to exchange the component.

The probability information may e.g. be determined based on how much fault symptom information of relevant fault reports has in common with fault symptoms of the occurring fault. Also, it may e.g. be based on fault remedy information of fault reports and e.g. result information of the remedy of the fault to which the relevant fault reports are related.

It is in general understood that any relevant data may be established in relation to establishing probability information and that also any suitable type of statistical analysis may be utilized in aspects of the invention.

In an aspect of the invention, the data processing comprises automatically establishing one or more suggestions to the cause of said occurring fault by means of automatically establishing fault cause information.

In some situations it can be advantageous to know the cause/reason for the fault in that this information may help a user (also sometimes referred to as operator or service person) to initiate the proper actions. For example, fault cause information together with fault remedy suggestions may help service personnel to faster and more cost efficiently remedying the occurring fault and/or suggest further relevant suggestions regarding how to remedy a fault.

As an example, the system according to aspects of the invention by a fault remedy suggestion recommends exchanging a given component in a wind turbine. Further, a fault cause suggests that the cause of the occurring fault is a fault in minor spare parts of a component. Thus, an operator may suggest that service personnel could bring both the relevant spare parts and a whole new component when trying to remedy the occurring fault.

However, in embodiments of the invention, the system may also utilize fault cause information to establish fault remedy suggestions. For example, in the above example, the system may suggest bringing the spare parts for the component.

In an aspect of the invention, one or more of the one or more fault reports comprises fault cause information regarding the cause of the previously occurred fault to which the respective fault report relates, and wherein said one or more suggestions to the cause of said occurring fault are established based on said fault cause information.

This may e.g. also be especially relevant in relation to establishing fault cause suggestions based on earlier experience obtained during previously occurred faults.

Alternatively, the fault cause suggestions may e.g. be established based on fault related data alone.

It may be very advantageous, if the cause of the fault become known during the remedying of the fault, to add the cause of the fault to the fault report related to that fault because this information is then available for the data processing when future faults occur.

In a further aspect of the invention, the data processing may furthermore comprise establishing probability information comprising information regarding one or more causes of said occurring fault being the most probable.

By this, several advantages may be obtained, e.g. in relation to trying to prevent future faults.

Furthermore, in aspects of the invention, the said data processing may comprise establishing fault diagnosis information comprising a suggestion to a diagnosis for said occurring fault.

Thus, by having a suggestion to one or more diagnosis, e.g. an expert user may also furthermore be able to select between one or more fault remedy suggestions. Also, the expert user may based on suggested diagnosis be able to come up with further fault remedy suggestions.

In an aspect of the invention, the processing may furthermore comprise establishing probability information comprising information regarding the probability that a suggested diagnosis of said occurring fault is the correct diagnosis of the occurring fault.

In preferred aspects of the invention, the processing may comprise one or more statistical analysis.

This/these statistical analysis may comprise any suitable statistical analysis of data from a plurality of fault reports, and said fault related data.

Also, the statistical analysis may comprise weighting data. For example, fault remedy information of fault reports having a few fault symptoms that are relevant to the occurring fault may be considered as being lees probable to remedy the occurring fault compared to fault reports having a larger number of fault symptom information relevant to the occurring fault. Thus, fault remedy information of such fault reports may be weighted higher than fault remedy information of fault reports considered less relevant when establishing fault remedy suggestions, probability information etc.

The statistical analysis may furthermore be relevant in relation to establishing probability information as described in this document, e.g. in relation to establishing probability information relating to fault cause, fault diagnosis, fault remedy suggestions and/or the like.

In an aspect of the invention, said processing comprises identifying data common to said fault related data and said fault reports.

For example, if fault symptom information of a fault report comprises parameter settings and/or sensor output data from sensors of a wind turbine exposed to the fault to which the fault report relates, the settings of similar/comparable parameters and output from similar/comparable sensors of the wind turbine exposed to the occurring fault may be considered similar.

Thus, relevant data may be correlated to establish valid fault remedy suggestions.

As an example, the fault related data may comprises parameter settings of one or more parameters of one or more wind turbines exposed to the occurring fault, and the one or more fault reports may comprises parameter information such as parameter setting and/or parameter identification considered identical/comparable to one or more parameters of said fault related data. In such a situation, the correlation may comprise correlating said parameter settings of said fault related data with said parameter information of said fault reports.

In an aspect of the invention, said method may comprise identifying and collecting further fault related data from said one or more wind turbines based on said correlation.

Thus, the correlation may be based on data that during the processing is found to be relevant for e.g. a further correlation.

It is understood that further fault related data in aspects of the invention may also be collected from any other relevant resource based on said correlation.

In an aspect of the invention, said correlation may comprise a first correlation and a second correlation, said method comprising:

identifying further fault related data to be collected based on said first correlation,

collecting said further fault related data, and

performing said second correlation, said second correlation comprising correlating said collected further fault related data with data from one or more of said fault reports.

Hence, e.g. more precise fault remedy suggestions, fault cause information, fault diagnosis information and probability information may be established based on earlier experience regarding relevant fault related data.

In aspects of the invention, said fault reports comprising data being correlated with said further fault related data comprises said fault reports utilized for identifying said further fault related data.

Hereby, the relevance of fault reports identified to be relevant may be further verified.

In an aspect of the invention, said fault symptom information of one or more of said one or more fault reports comprises wind turbine information data relating to the setup of the wind turbine to which the respective fault report relates,

wherein said fault related data comprises wind turbine data relating to the setup of the wind turbine exposed to said occurring fault, and

wherein said method comprises correlating said wind turbine information data of said fault related data with said data relating to the setup of the wind turbine exposed to said occurring fault so as to identify fault reports relating to wind turbines having characteristics in common with said one or more wind turbines exposed to said occurring fault.

Hereby, relevant fault reports that may comprise relevant data for further correlation may be easily identified. The reason for this may e.g. be that fault reports that relate to wind turbines that are e.g. installed in differing geographical locations, that comprises components that are different to the setup data of the wind turbine exposed to the occurring fault or the like may in certain situations be excluded as irrelevant to the occurring fault.

In an aspect of the invention, said fault related data and said fault symptom information comprises alarm information, and in such aspects said correlation may comprise correlating said alarm information.

Such alarm information regarding alarms triggered during the occurring fault and alarms triggered during the fault to which the respective fault reports relates may by correlation give a fast and reliable indication of fault reports that could be considered relevant to comprise relevant fault remedy information.

In an aspect of the invention, one or more fault reports may comprise operation limitation information relevant to the previously occurred fault that the respective fault report relates to, said operation limitation information comprising information defining circumstances that could allow a wind turbine exposed to said occurring fault to be kept in operation.

Thus, it may be suggested by the system that a wind turbine exposed to the occurring fault may be kept in operation by, e.g., being temporarily de-rated until the occurring fault is remedied.

In aspects of the invention, one or more of said one or more said fault reports comprises severity information regarding the severity of the previously occurred fault that the respective fault report relates to.

Hence, it may e.g. be possible for a user and/or the system according to the present invention to determine the order in which a plurality of fault should be remedied e.g. by selecting the most severe faults to be remedied first.

Furthermore this could also lead to a prioritization of faults if more than one fault occurs. The remedy of one fault may turn out to also remedy additional other faults e.g. it would be advantageous if the fault report gave suggestions to priority of which the faults should be remedied.

In aspects of the invention, the method may further comprise:

processing a plurality of previously logged data so as to identify fault remedy suggestions and fault symptom information,

establishing a plurality of fault reports based on said identified fault remedy suggestions and fault symptom information, and

storing said established fault reports in a fault report database.

Hereby, e.g. old data stored over time may be indexed to be implemented in different fault reports so that previous knowledge is added to be available in accordance with different aspects of the present invention. Also, data stored in different formats may be indexed and converted into another format which can be handled in accordance with aspects of the present invention.

In the above aspect, one or more experts may furthermore review the established fault reports before they are stored in said fault report database to verify the fault reports.

In aspects of the invention, the method may furthermore comprise the following steps:

establishing a fault report at least partly by means of a user unit, and

storing said established fault report in a fault report database.

It may be very advantageous if e.g. a service person at a location, e.g. at the location of the occurring fault may establish a fault report or at least add information to a fault report from a user unit such.

Preferably a software application for registering the information comprised by the fault report is installed on the user unit or the user unit is capable of communicating with a server on which such software application is installed.

Naturally, also in this aspect, one or more experts may furthermore review the established fault report to verify the fault report.

The invention may also be directed towards a user unit utilized for establishing fault reports and/or adding data to a fault report.

In aspects of the invention, the method may comprise establishing one or more probability information relating to one or more suggestions established in relation to said occurring fault.

Thus, e.g. a user may be able to identify the most relevant suggestions in relation to e.g. fault causes, fault diagnosis, fault remedy suggestions and/or the like.

The invention furthermore relates to a system for automatically identifying suggestions regarding how to remedy wind turbine faults said system comprising:

a plurality of fault reports, each fault report comprising:

fault symptom information comprising data of identified fault symptoms of a previously occurred fault, and

fault remedy information, said fault remedy information comprising data regarding how said previously occurred fault was remedied,

a data collection arrangement arranged to collect fault related data, said fault related data at least comprising data from one or more wind turbines exposed to an occurring fault,

a data processing arrangement arranged to correlate said fault related data with data from one or more of said fault reports,

wherein said system is adapted for establishing one or more fault remedy suggestions comprising suggestions regarding how to remedy said occurring fault related to said one or more wind turbines.

In aspects of the invention said system may be adapted to operate according to the method described in the claims.

In preferred aspects of the invention, output data from the processing arrangement such as fault remedy suggestions, fault cause information suggestions, fault diagnosis information suggestions and/or probability information is displayed to a user by means of a user display.

In further aspects of the invention, the system may determine that a suggestion to a wind turbine fault could be non-critical to the operation of the wind turbine, and in such situation, the system may automatically implement such a suggestion to remedy the fault. For example, if it is suggested that the wind turbine is restarted/reset, the system of the present invention may in aspects of the invention automatically transmit control signals to restart/reset the wind turbine.

In general, it is understood that the cause of a fault as described in this document relates to what triggered/what is the reason for the fault.

Also, in general, a diagnosis of a fault relates to what is wrong. For example, an analysis of e.g. causes or the nature of a fault may end up with a identifying a diagnosis.

Furthermore, in general, a fault remedy relates to how to solve a fault to get e.g. a wind turbine into operation again.

As one example, the cause to a fault seems to be a stroke of a lightning in the utility grid, the diagnosis is that one or more electronic components in a wind turbine are defect (due to the lightning), and the fault remedy is to exchange the defect electronic components.

It is understood that the aspects identified above may be combined in a multitude of varieties to achieve further aspects of the invention.

### BRIEF DESCRIPTION OF THE DRAWINGS

FIG. 1 illustrates a schematic view of an embodiment of the system according to embodiments of the invention,

FIG. 2. illustrates an embodiment of a fault report,

FIG. 3 illustrates an embodiment of establishing fault remedy suggestions,

FIG. 4 illustrates an embodiment of establishing fault remedy suggestions comprising a first and a second correlation of data,

FIG. 5 illustrates a further schematic view of an embodiment of the system according to embodiments of the invention, and

FIG. 6 illustrates displaying different output from the system to a user of the system according to embodiments of the invention.

### DETAILED DESCRIPTION OF THE INVENTION

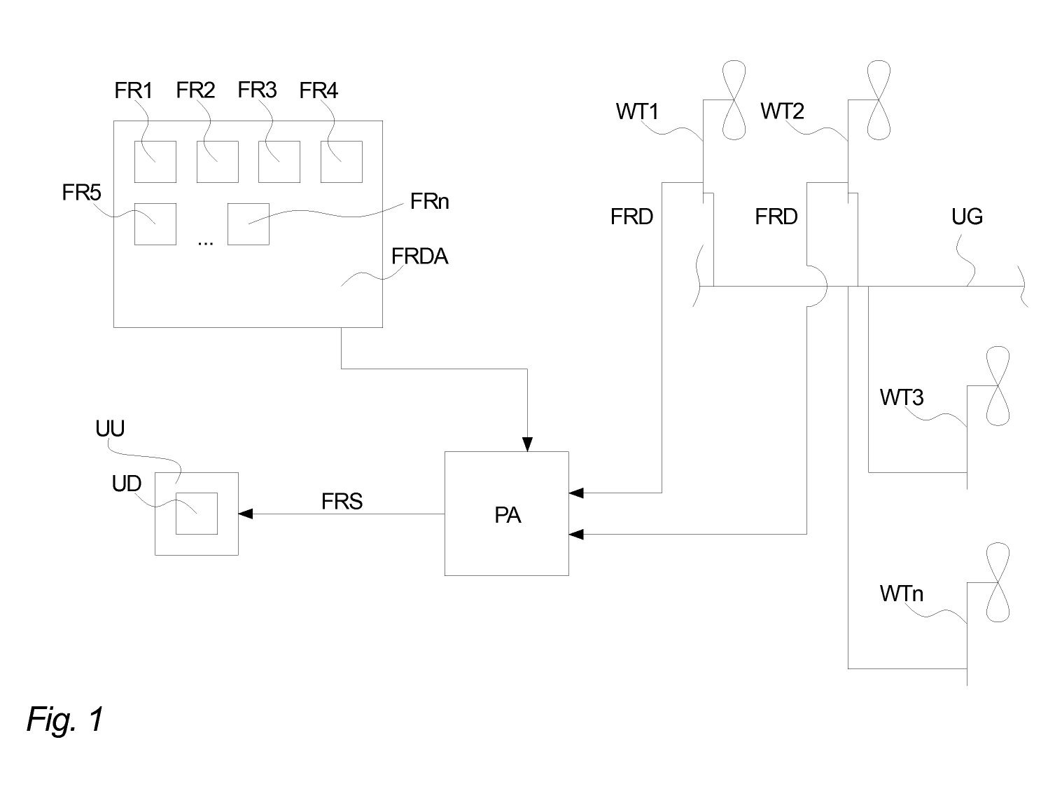

FIG. 1 illustrates an embodiment of the invention comprising a fault report database FRDA comprising a plurality of fault reports FR1, FR2, FR3, FR4, FR5 . . . FRn, wind turbines WT1-WTn, a processing arrangement PA and a user unit UU comprising a user display UD for displaying output data from the processing arrangement.

The processing arrangement PA receives/collects input data in the form of fault related data FRD from wind turbines exposed to an occurring fault F1. For example, the wind turbine(s) exposed to the fault F1 may be out of operation (i.e. not producing power) due to the fault, or may be exposed to the occurring fault but may remain in operation to produce power.

In the present example of FIG. 1, the wind turbines WT1 and WT2 are exposed to the occurring fault(s). The processing arrangement PA performs data processing to correlate the fault related data FRD with data from one or more of the fault reports FR1-FRn of the fault report database FRDA.

Based on the correlation performed by the processing arrangement PA, one or more fault remedy suggestions FRS are automatically established. The fault remedy suggestions FRS comprises suggestions regarding how to remedy the occurring fault(s) that the wind turbines, presently the wind turbines WT1 and WT2, are exposed to.

The wind turbines WT3 and WTn are not in the present example exposed to the occurring fault. However, the processing arrangement PA may also in embodiments of the invention collect/received data from these wind turbines to be processed, in that these wind turbines WT3, WTn may comprise data that may help to identify solutions to the occurring fault. For example by correlating data from wind turbines WT1, WT2 exposed to the occurring fault, and wind turbines not exposed to the occurring fault to identify outlying data of the wind turbines WT1, WT2 exposed to the occurring fault.

In general, it may be relevant to correlate data from wind turbines WT1-WTn comprising a substantially similar wind turbine setup.

Similar/comparable wind turbine setup may e.g. be defined as that the wind turbines WT1-WTn operates under similar and/or comparable operation conditions, that one or more wind turbine components and/or versions are similar or at least similar enough so that a correlation of such data from the wind turbines may help to establish fault remedy suggestions or the like.

Examples of similar and/or comparable operation conditions may e.g. comprise meteorological and/or geographical conditions under which the wind turbines WT1-WT4 operate.

Examples of one or more wind turbine components and/or versions that may be similar or substantially similar may comprise bearings, generator, switch gear, gearbox, converter, wind turbine blades, pitch arrangement, control system for pitching the blades, software version(s) of e.g. the wind turbine control system, sensor setup for monitoring conditions etc. in the wind turbines WT1-WTn.

Thus, fault symptom information of fault reports FR comprising e.g. wind turbine information data relating to the setup of a wind turbine to which the respective fault report (FR) relates, and fault related data FRD comprising wind turbine information data relating to the setup of the wind turbine exposed to the occurring fault F1 may be correlated. This correlation may be performed with the goal of identifying fault reports FR comprising data from wind turbines having characteristics in common with the wind turbine(s) exposed to the occurring fault F1. Such fault reports may e.g. be relevant in that there may be an increased chance that wind turbines having setup in common and which seems to comprise relevant fault symptom information may comprise relevant fault remedy information. The fault reports FR are described in more details later on.

It is noted that in FIG. 1, only four wind turbines WT1-WTn are illustrated, but it is naturally understood that data may be collected from a plurality of wind turbines WT and that the four wind turbines WT1-WTn are only illustrated for an explanatory purpose.

The user unit UU may be any appropriate unit facilitating receiving and displaying the fault remedy suggestions and other relevant data received from or at least processed by the processing arrangement PA. An example of user units UU may be a personal computer such as a laptop or a stationary computer, it may be a tablet, it may be a cell phone, a handheld service device and/or any other suitable device. For the purpose of displaying the fault remedy suggestion(s) and other relevant data received from or at least processed by the processing unit, a software application may be developed to be installed on the user unit, and it is furthermore understood that the user unit may comprise a data storage, a processing unit, at least an input arrangement for receiving the fault remedy suggestions FRS and other relevant data from the processing arrangement PA.

Also a user unit UU may in aspects of the invention be utilized for establishing a fault report. For example, by means of a software application comprising a template in which the user of the user unit UU may fill in information that is relevant to the occurring fault. For example, if the user, e.g. service personnel is inside the nacelle of a wind turbine exposed to an occurring fault and can smell and/or see that something seems wrong, this information may be added to a fault report FR and/or utilized during establishing of a new fault report FR at least partly by means of the user unit.

It is understood that the system may in embodiments comprise a plurality of user units UU. Some of the user units may be user units arranged at a first location and being e.g. adapted for receiving fault remedy suggestions and other data to be displayed, e.g. based on user input. Other user units UU may be arranged to facilitate establishing fault reports and maybe furthermore receive fault remedy suggestions from the system. Further, some user units UU may be arranged to alone facilitate establishment of new fault reports and/or amendments of existing fault reports. Also, user units may be adapted to receive information from an expert user regarding how a fault should be remedied, where the expert user have e.g. selected a fault remedy suggestion suggested by the system. So it is understood that the system in embodiments may comprise a plurality of user units that may be dedicated towards different purposes.

Furthermore, a new fault report FR may be created by service personal at the site of the wind turbine by means of a user unit so that e.g. both fault cause, fault diagnose and fault remedy may be typed in by the service personal on site.

In an embodiment, the processing arrangement PA is one central processing arrangement, but it may alternatively comprise two or more processing arrangements for processing data according to embodiments of the present invention. It is understood that the processing arrangement PA may comprise one or more data storages, one or more data processors, one or more suitable wired and/or wireless data communication arrangements for communicating with e.g. wind turbine control systems, other external data bases, user units, users of the system etc. It is furthermore understood that the processing arrangement PA in embodiments of the invention may process and store intermediate results for later use.

As illustrated in FIG. 1, the fault report database FRDA comprises a plurality of fault reports FR1-FRn. A fault report according to embodiments of the invention is explained in more details in the following.

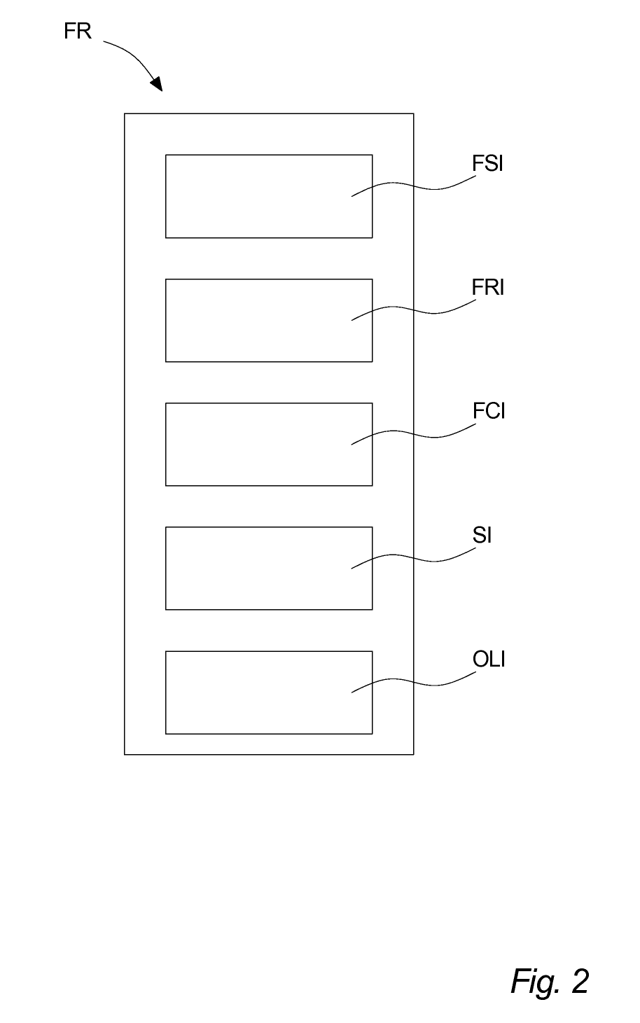

FIG. 2 illustrates an embodiment of a fault report FR stored/to be stored in a fault report database FRDA. A fault report FR relates to a previously occurred fault PF, e.g. a fault occurred and remedied previous to an occurring fault F1 that the system intends to establish one or more fault remedy suggestions FRS to.

The fault report FR as illustrated in FIG. 2 comprises a set of data e.g. comprising fault symptom information FSI and fault remedy information FRI. The fault symptom information FSI comprises data of identified fault symptoms of a previously occurred fault. The fault remedy information FRI comprises data regarding how the previously occurred fault, to which the fault report FR relates, was remedied.

A non-limiting list of examples of fault symptom information FSI may be:
Registered alarms trigged in the wind turbine to which the fault report relates and/or triggered alarms in other wind turbines,
Logged output from sensors in the wind turbine(s) exposed to the fault to which the fault report relates. The logged output may e.g. comprise data regarding the output from the sensors before and/or during the fault to which the fault report relates. Also e.g. data from sensors of wind turbines whose operation was not influenced by the fault to which the fault report relate may also be logged in the fault report.
Wind turbine setup data such as wind turbine component information and configuration of the specific wind turbine(s) and/or components that was exposed to the fault to which the fault report relates.
Time information such as time stamps regarding the time of the occurrence of the fault to which the fault report relates.
Information of the geographical location comprising e.g. characteristics of the geographical location of the wind turbine, etc.
The status of the wind turbine power production (e.g. out of operation, reduced power production, produced power type information (e.g. amount of reactive power and real power)) before and/or after the fault occurred
Utility grid data being relevant to the fault to which the fault report relates, e.g., data from substations, voltage data, electric current information, power type information etc. at one or more locations in the utility grid.
Meteorological data such as e.g. wind speed information, wind direction information, precipitation information, ambient temperature information etc.
Notes from an expert user.
Etc.

It is naturally understood that the fault symptom information FSI may comprise any relevant data that may be utilized to identify and/or describe fault symptoms that was triggered by and/or caused the fault to which the fault report FR relates.

Likewise, non-limiting examples of the fault remedy information FRI may comprise information regarding how fault was remedied, information regarding attempts to remedy the fault that did not succeed, etc. For example, the fault remedy information may comprise information text such as “Fault remedied by exchanging bearing”, “Fault remedied by reset of wind turbine”, “Fault remedied by repair of nearby substation in utility grid” etc. also, the fault remedy information may comprise text regarding non-successful fault remedy attempts such as “bearing rollers exchanged—did not remedy fault”, “vibration sensor exchanged—did not remedy fault”. The formulation of such text is not important unless it forms part of the correlation, in this case the text may need to comply with a predefined syntax. Also, different predefined codes or abbreviations for the non-successful and/or successful fault remedy attempts.

Also the fault remedy information may be implemented in a table such as Table 1 below. It is understood that Table 1 below is a non-limiting example.

TABLE 1

| Fault remedy suggestions | Fault remedied | Fault not remedied |
|---|---|---|
| Main bearing exchanged | X | |
| Bearing rollers exchanged | | X |
| Vibration sensor exchanged | | X |
| Alignment of drive train | | X |

Thus, is can be seen from the fault remedy information in Table 1 of the fault report FR that alignment of the components of the drive train, exchange of bearing rollers and exchange of vibration sensor was tried in order to remedy the fault that the fault report relates to, but that these remedy attempts did not remedy the fault. However, the fault was remedied by exchanging a bearing. In some situations, such fault remedy information may be utilized to exclude fault remedy suggestions that based on other fault reports may seem to be likely to remedy a fault.

In the following, a specific and non-limiting example regarding an occurring fault F1 is described. A fault report FR may relate to a previously occurred fault PF in the form of a bearing fault in a wind turbine. It turned out that the bearing fault was triggered based on output from one or more vibration sensors sensing vibrations in the wind turbine. The output from the vibration sensor may for example have been compared with a predefined vibration pattern, and if the predefined vibration pattern and the output from the vibration sensor deviate in a certain way, an alarm may automatically be set in the wind turbine. The bearing fault was remedied by exchanging the bearing.

Now, the fault symptom information FSI of a fault report generated in relation to this bearing fault example may e.g. comprise:
Triggered alarms relating the bearing fault,
A logged output of the vibration sensor output comprising data regarding the vibrations up to and/or during the bearing fault.
Bearing data (e.g. bearing type, age, size etc.)
Wind turbine setup data (e.g. comprising wind turbine component information of the specific wind turbine that was exposed to the bearing fault).
Time information regarding the occurrence of the fault
The status of the wind turbine power production (e.g. “out of operation”, reduced power production, fluctuations in the produced power before and/or after the fault occurred etc.)
Relevant parameters and/or parameter settings of wind turbine exposed to the fault
Etc.

Likewise, the fault remedy information FRI may comprise information regarding how the bearing fault was remedied. In the present example, the fault remedy information FRI may e.g. comprise the information that the bearing was exchanged to remedy the bearing fault. Also, the fault remedy information may comprise the information that a resetting/calibration of the vibration sensor and a restart of the control system of the wind turbine did not remedy the fault.

Furthermore, the fault report FR may in embodiments of the invention comprise fault cause information FCI as illustrated in FIG. 2. The fault cause information comprises information regarding the cause of the fault PF to which the fault report FR relates. For example in the example of the bearing fault described above, the fault cause information FCI may comprise the information that the lubrication of the bearing for some reason seems to have been insufficient, e.g. because a system of the wind turbine for lubricating the bearings turned out to be defect, because that service personnel by mistake omitted to lubricate the bearing during the last service inspections or the like. This information may e.g. be added to the fault report manually by a repairman, and/or may be automatically added to the fault report at some point. Fault cause information FCI may e.g. give raise to development of e.g. survey software so that e.g. is was automatically detected that the repairman forgot to lubricate the bearing.

Also, the fault report FR may in embodiments of the invention comprise severity information SI regarding the severity of the fault PF that the fault report FR relates to. The severity information may comprise a severity rating (e.g. “extremely severe”, “severe”, “Severe over time if not corrected” “Not severe” or the like. Also, the severity information may comprise notes from an expert user regarding the severity of the fault.

In embodiments of the invention a fault report FR may comprise operation limitation information OLI relevant to the fault PF that the fault report FR relates to. The operation limitation information OLI may comprise information defining circumstances that could allow a wind turbine exposed to the fault PF to remain in operation even if being exposed to the fault PF to which the fault report relates FR.

In the above example of the bearing fault, the operation limitation information OLI may comprise the information that the wind turbine could be allowed to remain in operation if being temporarily de-rated to produce a predefined lower amount of power than the rated maximum power of the wind turbine, and during wind speeds not producing power above a predefined wind speed.

Non-limiting examples of collected fault related data FRD may comprise e.g.:
Time stamps,
Parameter settings of wind turbines,
Meteorological data,
Data logs comprising data from the utility grid, sub-stations etc.,
Alarm status of wind turbines,
Parameter information and/or parameter settings of wind turbines,
Measurements from sensors in the wind turbine,
Power output from wind turbines,
Alarm statistics,
Component data from wind turbines,
Data logs from wind turbines,
Utility grid data,
Etc.

This data may be correlated with the data of a plurality of fault reports to establish fault remedy suggestions based on fault remedy information of the fault reports.

In general, it is understood that the processing performed by the processing arrangement PA may comprise a plurality of various suitable types of statistical analysis of data from fault reports and collected fault related data as well as other data, it may comprise identifying fault reports FR comprising fault symptom information FSI having most in common with collected fault related data etc.

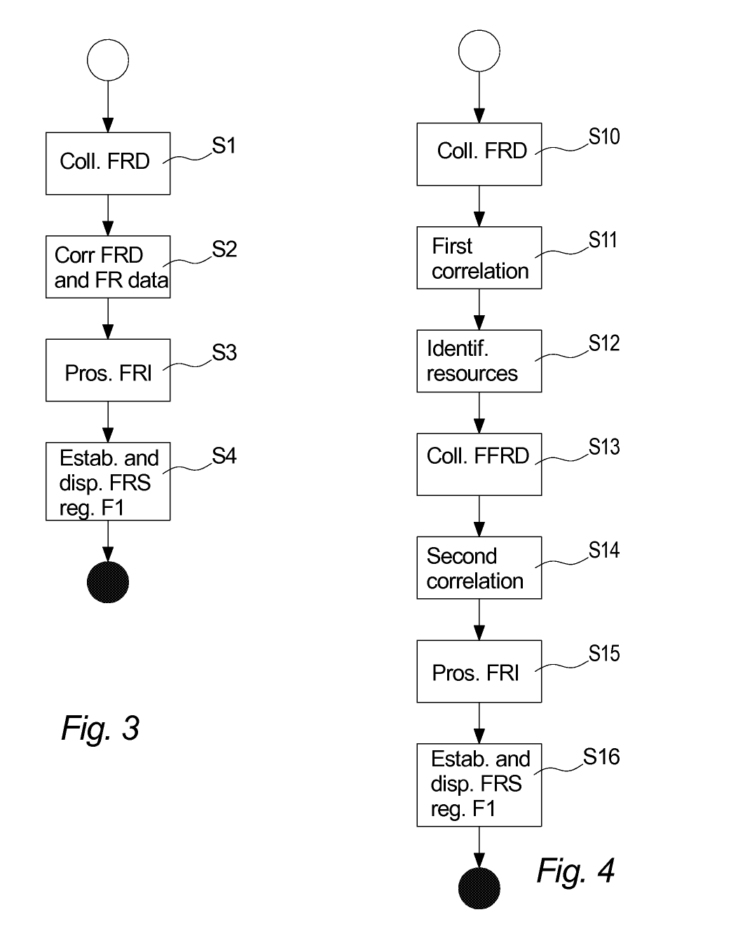

FIG. 3 illustrates an embodiment of the process to establish one or more fault remedy suggestions regarding the occurring fault F1.

In the situation of FIG. 3, a wind turbine is exposed to a first fault F1, also referred to as occurring fault F1. At step S1, the system collects fault related data FRD from the wind turbine exposed to the occurring fault F1, and possibly also from other sources such as e.g. databases comprising relevant metrological data from the wind turbine site, data from the utility grid, data from databases comprising e.g. logged data from the wind turbine exposed to the occurring fault, data from other wind turbines, e.g. of the same wind turbine park if the wind turbine exposed to the fault is located in a wind turbine park, etc.

At step S2, this fault related data is processed by the processing arrangement, and is correlated with data from a plurality of stored fault reports FR1-FRn so as to identify fault reports relating to previously occurred faults PF that has occurred previous to the occurring fault F1, and that may be considered comparable to the occurring fault F1 due to e.g. the fault symptom information of these stored fault reports.

As a non-limiting example, the occurring fault F1 may e.g. relates to an alarm triggered by a temperature sensor in a wind turbine sensing a temperature in a wind turbine component being above a predefined level. The system correlates, e.g. by means of one or more algorithms, fault related data FRD comprising this information with data of a plurality of fault reports FR in a fault report database FRDA to identify fault reports FR with fault symptom information FSI comprising that the same (or a comparable) alarm was triggered e.g. in another wind turbine.

Also, various other fault symptom information FSI of fault reports FR, comprising the information that the same (or a comparable) alarm was triggered, with other fault related data FRD may be correlated. For example, if the fault reports FR identified to comprise that an identical (or a comparable) alarm was triggered comprises further relevant fault symptom information FSI such as for example fault symptom information relating to:
Wind speed at the time of the fault PF that may have an impact on the fault to which the respective fault report relates,
If other faults occurred at the same time, previous to the time and/or after the time that the fault to which the respective fault report relates,
Utility grid behavior at the time of the fault PF to which the respective fault report relates,
That nearby wind turbines reacted in a certain way due to the fault to which the respective fault report relates,
Etc.

This fault symptom information FSI may be correlated with collected fault related data FRD describing wind speed data, data regarding further occurring faults, utility grid information, the behavior of nearby of comparable wind turbines, etc. to establish a more precise suggestion of how to remedy the occurring fault.

In general, the correlation may e.g. be performed by one or more algorithms e.g. utilizing one or more known correlation methods, statistical methods, exclusion methods and/or the like to process data such as fault related data FRD, data from the fault reports and other relevant data with the goal of establishing fault remedy suggestions and possibly other suggestions and/or information described in embodiments and combinations of such disclosed in this document.

In step S3, fault remedy information FRI of the fault reports FR considered relevant to the occurring fault F1 is processed based on the above mentioned correlation. This fault remedy information FRI may most likely comprise some relevant hints regarding how the occurring fault F1 may be remedied. The reason for this is that the relevant fault reports comprises fault symptom information that e.g. coincides in some way with fault symptoms of the occurring fault F1.

So, based on the fault remedy information FRI of the relevant fault reports FR, the system is now capable of automatically establishing fault remedy suggestions that may have a good chance of remedying the occurring fault F1 based on earlier experiences regarding remedying similar and/or comparable faults.

It is naturally understood that the correlation may also comprise a user entering some relevant data to be processed, e.g. data obtained from a wind turbine visually by e.g. a wind turbine repairman. This information may be entered e.g. by means of the user unit UU and may be transmitted to the processing arrangement.

The established fault remedy suggestions are then e.g. displayed to a user (step S4) by means of a user display UD as illustrated in FIG. 1.

FIG. 4 illustrates a flow chart substantially similar to the flowchart of FIG. 3. However, in this embodiment, the system identifies relevant further fault related data FFRD that is not yet available for the processing arrangement PA. Such further fault related data FFRD may thus be included in the correlation.

Such relevant further fault related data FFRD may by correlation with data from the fault reports e.g. help to verify relevant fault remedy information FRI. Also, it may help to narrow the amount of relevant fault remedy information FRI that seem to be relevant as fault remedy suggestions FRS that may be capable of remedying the occurring fault F1.

In such embodiments, the correlation may comprise a first correlation and a second subsequent correlation as described in the following. It is however understood that the first correlation and the second correlation in embodiments of the invention may overlap and be a part of an iterative process, and that the system in embodiments of the invention may comprise a plurality of correlations. Also, in embodiments of the invention, the first and second correlations (and even further correlations) may be implemented in one overall correlation process.

Now, turning to a more detailed explanation of FIG. 4, fault related data FRD is collected in step S10.

At step S11, collected fault related data FRD is processed, and is by a first correlation correlated with data from a plurality of stored fault reports FR1-FRn so as to identify fault reports relating to previously occurred faults PF that may be considered comparable to the occurring fault F1.

During the first correlation, further fault related data FFRD, which could be relevant in relation to e.g. suggesting remedies to the occurring fault F1, may be identified. Such further fault related data FFRD could e.g. be data corresponding to/defined by fault symptom information FSI from fault reports FR which relates to previous faults PF that are identical and/or comparable to the occurring fault F1.

In step 12 relevant resources such as data resources from which relevant further fault related data FFRD may be collected, is identified.

As a non-limiting example, a fault report FR relating to a previously occurred fault PF identified by the first correlation seems relevant. This fault report FR may comprise fault symptom information FSI comprising the status/setting of one or more parameters in wind turbines near the wind turbine which were exposed to this previously occurred fault PF.

Since this previously occurred fault PF and the occurring fault F1 seems substantially similar, the settings of parameters from wind turbines near the wind turbine exposed to the occurring fault F1 may be relevant in establishing a more reliable fault remedy suggestion FRS to the occurring fault F1. In this case such settings of parameters could be defined as further fault related data FFRD that could be relevant to collect and correlate with data from fault reports.

Also, when establishing the fault report FR of the occurring fault F1, the system may not have access to the setting/status of these parameters.

Thus, the system may identify relevant resources from where it is possible to collect further fault related data FFRD based on the fault report FR relating to the previously occurred fault PF. In this case wind turbines near the wind turbine exposed to the occurring fault F1 or logged data from these wind turbines are considered relevant.

Thus collection of the parameter settings/statuses similar/comparable to the parameter settings/statuses defined in the fault report FR related to the previously occurred fault PF is facilitated.

The further fault related data FFRD is then collected from proper identified resources in step S13, and in step S14, a second correlation of the further fault related data FFRD and data from fault reports is performed.

In step S15, fault remedy information FRI of relevant fault reports FR identified during the first correlation and/or the second correlation and being considered relevant to the occurring fault F1 are identified. Based on this fault remedy information, fault remedy suggestions are in step S16 established and e.g. displayed to a user.

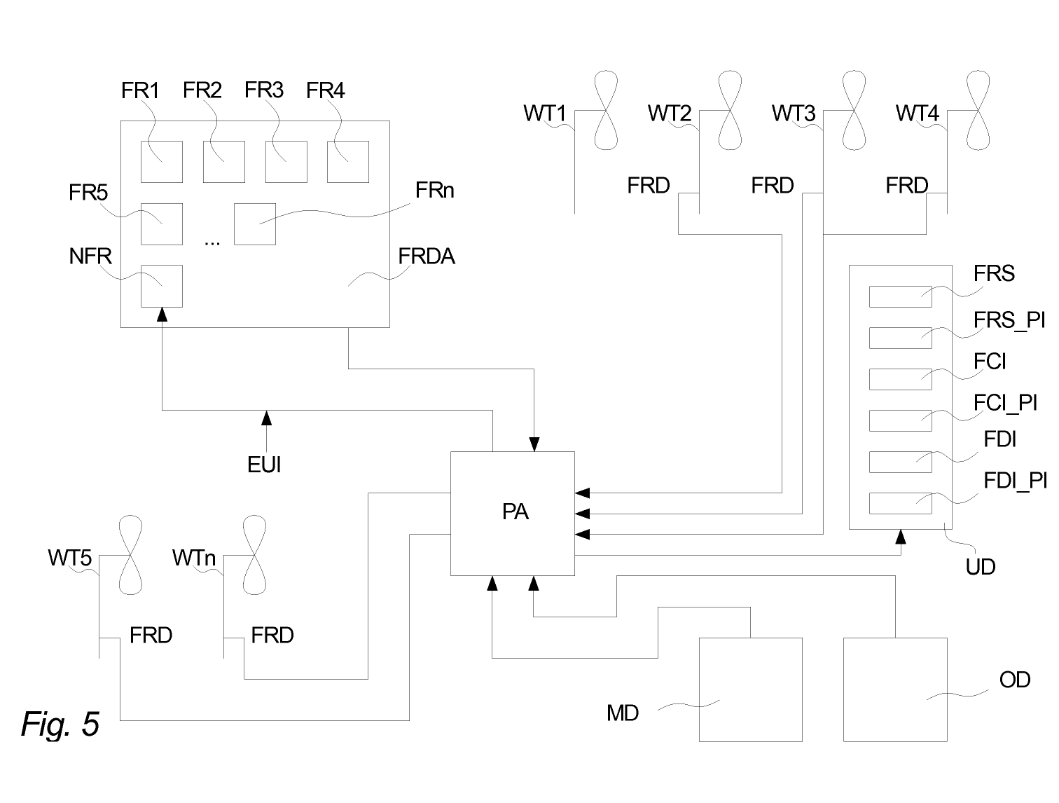

FIG. 5 illustrates further embodiments of the invention. In embodiments of the invention, the processing arrangement PA may collect meteorological data MD and other relevant data OD from a plurality of different external data sources, e.g. as described previously in this document. Also, it is understood that the processing arrangement PA may collect data from different wind turbine sites. This is illustrated by the processing arrangement PA collecting data from three wind turbines, WT2, WT3 and WT4 of a first wind turbine site, e.g. a first wind turbine park, and data from two other wind turbines WT5, WTn from another site such as another wind park.

Also, the system may according to embodiments of the invention establish new fault reports NFR regarding the occurring and remedy of fault F1 automatically or at least semi-automatically with some sort of expert user input and/or verification.

Hence, when fault remedy suggestions FRS regarding an occurring fault F1 is established, and preferably also when the occurring fault F1 is remedied, relevant data relating to the occurring fault F1 and the remedy of this fault can be utilized subsequently for establishing a new fault report NFR. This new fault report NFR is then afterwards regarded as a fault report FR relating to a previously occurred fault PF.

In a preferred embodiment of the invention, the new fault report NFR is verified by an expert user by means of expert user input EUI. The verification may comprise a safety check of the new fault report NFR and maybe also modifying the new fault report NFR by incorporating further data e.g. by or amending, correcting or adding information to the new fault report NFR.

In an embodiment of the invention, the new fault report NFR is first accessible after being verified by the expert. In further embodiments of the invention, verification information may be displayed to a user together with fault remedy suggestions FRS, so a user knows if fault remedy suggestions FRS originates from fault reports FR that are verified or not.

It is understood that the new fault report NFR comprises fault symptom information FSI describing fault symptoms of the fault F1 that is now remedied, and fault remedy information FRI comprising information regarding how the fault F1 was remedied, and may also comprise further data as described in relation to e.g. FIG. 2.

Also, it is to be understood that fault reports FR that already exist in the fault report database FRDA in embodiments of the invention may be updated, e.g. by new and/or corrected fault symptom information FSI and/or fault remedy information FRI that is identified after the fault reports FR have been established and stored in the database FRDA.

So now, the new fault reports NFR and/or updated fault reports may subsequently be utilized for establishing fault remedy suggestions FRS comprising suggestions regarding how to remedy a subsequent occurring fault in one or more wind turbines WT.

Also, it is understood that the system may establish a plurality of individual fault reports based on one occurring fault.

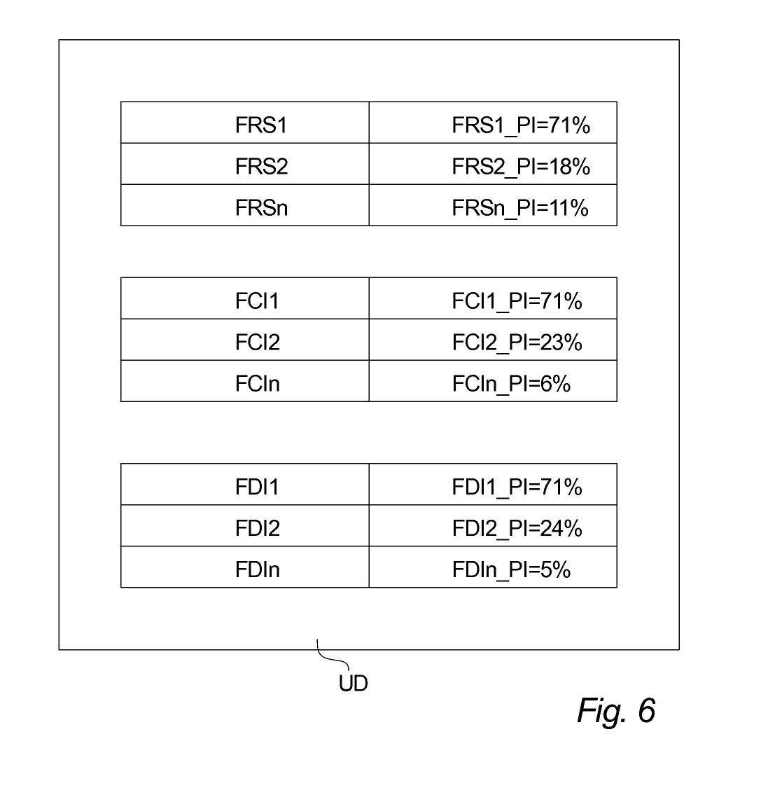

FIG. 5 also illustrates a further embodiment of the invention where fault remedy suggestion(s) FRS, fault remedy probability information FRS_PI, fault cause information FCI, fault cause probability information FCI_PI, fault diagnosis information FDI and fault diagnosis probability information FDI_PI are established and displayed to a user via a user display UD. This is explained in more details in relation to FIG. 6.

In FIG. 6, the result of a correlation reveals a number of suggestions FRS1-FRSn to remedy the occurring fault F1. Also information regarding e.g. the geographical location, the wind turbine type, wind turbine setup and other data regarding the wind turbine exposed to the occurring fault F1 may in embodiments be displayed to the user via a user display UD. It is understood that the example of FIG. 6 is solely for an explanatory purpose.

As illustrated in FIG. 6, fault remedy suggestions FRS suggesting how to remedy an occurring fault F1 are displayed to the user by means of a user display UD. In the present example, three fault remedy suggestions FRS1-FRSn are displayed, but it is understood that more or less fault remedy suggestions FSR may be displayed dependent of the result of the correlation performed by the data processing arrangement PA.

In the present embodiment, each fault remedy suggestion FRS1-FRSn is accompanied by probability information FRS1_PI-FRS3_PI indicating the estimated probability of each fault remedy suggestion FRS remedying the occurring fault F1. Take for instance the earlier described bearing fault example. Three fault remedy suggestions FRS may be established, e.g.:

FRS1=Exchange main bearing and/or bearing rollers.

FRS2=Restart/reset wind turbine.

FRS3=Exchange vibration sensor. (TYPE ID)

Now, the system has as illustrated estimated that there is e.g. a 71% chance that exchanging the bearing or some of its components will remedy the occurring bearing fault in the wind turbine, that there is e.g. a 18% chance that a reset of the wind turbine will be able to remedy the fault, and that there is e.g. a 11% chance that exchanging the vibration sensor triggering the bearing fault will remedy the occurring fault F1. Now, even though a user from the above information can see that exchanging the bearing will be the most likely solution to remedy the occurring fault, it will clearly also be the most cost expensive solution. Therefore, a user may initiate suggestion 2, i.e. the resetting/restart of the wind turbine (e.g. a remotely controlled resetting), before sending a repairman to the wind turbine with a bearing and a vibration sensor. It is understood that the system after the resetting may recalculate and update fault remedy suggestions FRS and the corresponding probability information FRS_PI.

It is understood that the system in embodiments of the invention may also display relevant component information in relation to fault remedy suggestions FRS so that a user can determine the specific type of component that should e.g. be repaired and/or exchanged directly from the fault remedy suggestion FRS.

As illustrated in FIG. 6, fault cause information FCI1-FCI3 may also be established and displayed to the user in a display.

In the present example, three fault cause information FCI suggestions are established e.g.:

FCI1=Fault caused by bearing lubrication error

FCI2=Fault caused by utility grid related fault

FCIn=Fault caused by overcurrent in wind turbine control system

In the present example, the system has estimated that there is e.g. a 71% risk that the occurring bearing fault is caused by insufficient lubrication of the bearing, that there is e.g. 23% risk that the fault has occurred due to a fault in the utility grid (e.g. a short circuit, lightning strike in utility grid nearby, a voltage drop etc. which may have had an impact on the vibration sensor), and that there is 6% risk that the fault is caused by an overcurrent in the wind turbine.

It is understood that the fault cause information FCI and the accompanying probability information PI may be established by correlating data from a plurality of fault reports FR and collected fault related data FRD. However, the fault cause information FCI may also in embodiments of the invention be established by collected fault related data FRD alone. For example, if the system collects logged data regarding e.g. the utility grid behavior, the system may determine that at the specific time that the occurring fault began, a stroke of lightning was detected in a nearby wind turbine causing a transient in the wind turbine exposed to the fault. So in e.g. such a case, a grid related fault would be probable.

As indicated, the system may also establish and display fault diagnosis information FDI relating to probable diagnoses for the occurring fault F1.

In the present example, three fault diagnosis information FDI suggestions are established e.g.:

FDI1=Broken bearing rollers in main bearing.

FDI2=Wind turbine control system error

FDIn=Failure in bearing vibration sensor

In the present example, the system has estimated that there is e.g. a 71% risk that the diagnosis of the occurring fault F1 is that the rollers of the main bearing are broken, that there is e.g. 24% risk that the diagnosis of the occurring fault F1 is a wind turbine control system error, and that there is 5% risk that the diagnosis of the fault is a broken main bearing vibration sensor. As noticed also in relation to the fault diagnosis information FDI a probability information PI is estimated.

It is furthermore understood that relevant severity information SI and operation limitation information OLI as described above in embodiments of the invention may be displayed to the user.

In general, it is to be understood that the invention is not limited to the particular examples described above but may be adapted in a multitude of varieties within the scope of the invention as specified in the claims. Furthermore, it is to be understood that two or more embodiments and/or features illustrated in the figures may also be combined in a multitude of varieties to achieve different embodiments not directly described in this document. For example, it is understood that the invention is not limited to the specific examples of faults mentioned in this document. For example the present invention may be utilized for establishing fault remedy suggestions to any type of fault such as faults in e.g. wind turbine components of wind turbines, faults in wind turbine control software and/or faults occurred in the utility grid, based on correlation of data of fault reports and collected fault related data.

List
FRDA: Fault report database
FR, FR1-FRn: Fault reports
NFR: New fault report
FRS: Established fault remedy suggestion
PA: Processing arrangement
WT1-WTn: Wind turbines
FRD: Fault related data
FSI: Fault symptom information
PF: Previously occurred fault
FRI: Fault remedy information
F1: Occurring fault
FCI: Fault cause information
PI: Probability information
FFRD: Further fault related data
EUI: Expert user input
FRS_PI: Probability information regarding the probability that a fault remedy suggestion will remedy an occurring fault.
FCI_PI: Probability information regarding the probability that a suggested cause of an occurring fault is the correct cause of the occurring fault.
FDI_PI: Probability information regarding the probability that a suggested diagnoses of an occurring fault is the correct diagnosis of the occurring fault.

1. A method of automatically identifying suggestions regarding how to remedy wind turbine faults, said method comprising:
establishing and storing a plurality of fault reports, each fault report comprising:
fault symptom information comprising data of identified fault symptoms of a previously occurred fault, and
fault remedy information, said fault remedy information comprising data regarding how said previously occurred fault was remedied,
collecting fault related data, said fault related data comprising data from one or more wind turbines exposed to an occurring fault,
by a data processing arrangement performing data processing, said data processing comprising correlation of said fault related data with data from one or more of said stored fault reports, and
based on said correlation establishing one or more fault remedy suggestions comprising suggestions regarding how to remedy said occurring fault related to said one or more wind turbines based on said data processing.

2. The method according to claim 1, said method further comprising automatically establishing one or more a-new fault reports based on said data processing, said one or more new fault reports comprising:
fault symptom information describing one or more fault symptoms of said occurring fault, and
fault remedy information, said fault remedy information comprising information regarding how to remedy said occurring fault.

3. (canceled)

4. The method according to claim 2, wherein said one or more new fault reports and/or said updating of said one or more existing fault reports in said fault report database is/are being reviewed and if verified by an expert user via expert user input.

5. The method according to any of claims 2, wherein said one or more new fault reports and/or said one or more updated fault reports are subsequently automatically utilized for establishing one or more fault remedy suggestions comprising suggestions regarding how to remedy a subsequent occurring fault in one or more wind turbines.

6. The method according to claim 1, wherein one or more of said one or more wind turbines from which said fault related data is collected are out of operation due to said occurring fault.

7. The method according to claim 1, wherein said data processing further comprises establishing probability information for one or more of said established fault remedy suggestions, said probability information comprising information regarding the probability of said one or more fault remedy suggestions remedying said occurring fault.

8. The method according to claim 1, wherein said data processing comprises automatically establishing one or more suggestions to the cause of said occurring fault by automatically establishing fault cause information.

9. The method according to claim 8, wherein one or more of said one or more fault reports comprises fault cause information regarding the cause of the previously occurred fault to which the respective fault report relates, and wherein said one or more suggestions to the cause of said occurring fault are established based on said fault cause information.

10. The method according to claim 1, wherein said data processing further comprises establishing probability information comprising information regarding one or more causes of said occurring fault being the most probable.

11. The method according to claim 1, wherein said data processing further comprises establishing fault diagnosis information comprising a suggestion to a diagnosis for said occurring fault.

12. The method according to claim 11, wherein said data processing further comprises establishing probability information comprising information regarding the probability that a suggested diagnosis of said occurring fault is the correct diagnosis of the occurring fault.

13. The method according to claim 1, wherein said data processing comprises one or more statistical analysis.

14. (canceled)

15. The method according to claim 1, comprising identifying and collecting further fault related data from said one or more wind turbines based on said correlation.

16. The method according to claim 1, wherein said correlation comprises a first correlation and a second correlation, said method further comprising:
identifying further fault related data to be collected based on said first correlation,
collecting said further fault related data, and
performing said second correlation, said second correlation comprising correlating said collected further fault related data with data from one or more of said fault reports.

17. (canceled)

18. The method according to claim 1, wherein said fault symptom information of one or more of said one or more fault reports comprises wind turbine information data relating to the setup of the wind turbine to which the respective fault report relates,
wherein said fault related data comprises wind turbine data relating to the setup of the wind turbine exposed to said occurring fault, and
wherein said method comprises correlating said wind turbine information data of said fault related data with said data relating to the setup of the wind turbine exposed to said occurring fault so as to identify fault reports relating to wind turbines having characteristics in common with said one or more wind turbines exposed to said occurring fault.

19. (canceled)

20. The method according to claim 1, wherein one or more of said one or more fault reports comprises operation limitation information relevant to the previously occurred fault that the respective fault report relates to, said operation limitation information comprising information defining circumstances that could allow a wind turbine exposed to said occurring fault to be kept in operation.

21. (canceled)

22. The method according to claim 1, said method comprising:
processing a plurality of previously logged data so as to identify fault remedy suggestions and fault symptom information,
establishing a plurality of fault reports based on said identified fault remedy suggestions and fault symptom information, and
storing said established fault reports in a fault report database.

23. (canceled)

24. The method according to claim 1, said method comprising establishing one or more probability information relating to one or more suggestions established in relation to said occurring fault.

25. A system for automatically identifying suggestions regarding how to remedy wind turbine faults said system comprising:
a plurality of fault reports, each fault report comprising:
fault symptom information comprising data of identified fault symptoms of a previously occurred fault, and
fault remedy information, said fault remedy information comprising data regarding how said previously occurred fault was remedied,
a data collection arrangement arranged to collect fault related data, said fault related data at least comprising data from one or more wind turbines exposed to an occurring fault,
a data processing arrangement arranged to correlate said fault related data with data from one or more of said fault reports,
wherein said system is adapted for establishing one or more fault remedy suggestions comprising suggestions regarding how to remedy said occurring fault related to said one or more wind turbines.

26. A system adapted to operate according to the method of claim 1, said system comprising:
a plurality of fault reports, each fault report comprising:
fault symptom information comprising data of identified fault symptoms of a previously occurred fault, and
fault remedy information, said fault remedy information comprising data regarding how said previously occurred fault was remedied,
a data collection arrangement arranged to collect fault related data, said fault related data at least comprising data from one or more wind turbines exposed to an occurring fault,
a data processing arrangement arranged to correlate said fault related data with data from one or more of said fault reports,
wherein said system is adapted for establishing one or more fault remedy suggestions comprising suggestions regarding how to remedy said occurring fault related to said one or more wind turbines.
